(19) United States
(12) Patent Application Publication
(10) Pub. No.: US 2025/0117973 A1
(43) Pub. Date: Apr. 10, 2025

(54) STYLE-BASED IMAGE GENERATION

(71) Applicant: ADOBE INC., SAN JOSE, CA (US)

(72) Inventors: Fengbin Chen, Los Gatos, CA (US); Midhun Harikumar, Sunnyvale, CA (US); Ajinkya Gorakhnath Kale, San Jose, CA (US); Hareesh Ravi, San Jose, CA (US); Venkata Naveen Kumar Yadav Marri, Newark, CA (US)

(21) Appl. No.: 18/903,151

(22) Filed: Oct. 1, 2024

Related U.S. Application Data
(60) Provisional application No. 63/588,394, filed on Oct. 6, 2023.

(51) Int. Cl. G06T 11/00

(52) U.S. Cl. CPC G06T 11/00; G06T 2211/441

(57) ABSTRACT

A method, apparatus, non-transitory computer readable medium, and system for media processing includes obtaining a text prompt and a style input, where the text prompt describes image content and the style input describes an image style, generating a text embedding based on the text prompt, where the text embedding represents the image content, generating a style embedding based on the style input, where the style embedding represents the image style, and generating a synthetic image based on the text embedding and the style embedding, where the text embedding is provided to the image generation model at a first step and the style embedding is provided to the image generation model at a second step after the first step.

### CROSS-REFERENCE TO RELATED APPLICATION

This application claims priority under 35 U.S.C. § 119 to U.S. Provisional Application No. 63/588,394, filed on Oct. 6, 2023, in the United States Patent and Trademark Office, the disclosure of which is incorporated by reference herein in its entirety.

### BACKGROUND

The following relates generally to machine learning, and more specifically to image generation using machine learning. Machine learning is an information processing field in which algorithms or models such as artificial neural networks are trained to make predictive outputs in response to input data without being specifically programmed to do so. For example, a machine learning model can be trained to predict an output image using image training data. In some cases, a machine learning model can be trained to generate an output image based on a text input, an image input, an additional input or inputs, or a combination thereof.

### SUMMARY

Systems and methods are described for generating an image based on style information, where the style information helps to determine an appearance of the image. In one example, the style information is used to inform a later step or steps of an image generation process. By using the style information in the later step or steps, rather than each step of the image generation process, the style information is caused to be consistently apparent in the output. Furthermore, by using the style information in the later step or steps, rather than each step of the image generation process, the style information does not overwhelm other information used for generating the image (such as a text prompt or an image input describing content for the image), and an intended structure of the image provided by the other information is maintained in the image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for generating an image according to aspects of the present disclosure.

FIG. 3 shows an example of comparative generated images according to aspects of the present disclosure.

FIG. 4 shows a first example of synthetic images according to aspects of the present disclosure.

FIG. 5 shows an example of data flow in an image generation system according to aspects of the present disclosure.

FIG. 6 shows an example of data flow in a style encoder according to aspects of the present disclosure.

FIG. 7 shows an example of a user interface for providing a style input according to aspects of the present disclosure.

FIG. 8 shows an example of a user interface for displaying synthetic images according to aspects of the present disclosure.

FIG. 9 shows an example of a guided diffusion model according to aspects of the present disclosure.

FIG. 10 shows an example of a U-Net according to aspects of the present disclosure.

FIG. 11 shows an example of a method for generating a synthetic image based on a text prompt according to aspects of the present disclosure.

FIG. 12 shows an example of a method for generating a synthetic image based on an image according to aspects of the present disclosure.

FIG. 13 shows a second example of synthetic images according to aspects of the present disclosure.

FIG. 14 shows an example of a method for conditional generation according to aspects of the present disclosure.

FIG. 15 shows an example of a diffusion process according to aspects of the present disclosure.

FIG. 16 shows an example of a flow diagram depicting an algorithm as a step-by-step procedure for training a machine learning model according to aspects of the present disclosure.

FIG. 17 shows an example of a method for training a diffusion model according to aspects of the present disclosure.

FIG. 18 shows an example of a computing device according to aspects of the present disclosure.

FIG. 19 shows an example of an image generation apparatus according to aspects of the present disclosure.

FIG. 20 shows an example of a machine learning model according to aspects of the present disclosure.

### DETAILED DESCRIPTION

A machine learning model can be trained to generate an output image based on a text input, an image input, an additional input or inputs, or a combination thereof. Some conventional image generation models attempt to generate a stylized synthetic or synthesized image based on an input that includes content information and style information for the synthetic image, where the content information is intended to inform an object depicted in the synthetic image and the style information is intended to inform the style with which the content is depicted.

However, conventional machine learning models do not consistently apply styles to a synthetic image, or undesirably modify an intended structure of the synthetic image (such as content intended to be depicted in the synthetic image, or an intended view or orientation of content depicted in the synthetic image) when using style information as input. Accordingly, embodiments of the present disclosure provide an image generation system that accurately and efficiently generates a stylized synthetic image based on content information and style information. In one example, an image generation model of the image generation system uses the style information as guidance at a later step or steps of an image generation process, thereby causing the style information to be consistently apparent in the synthetic image without modifying the intended content or structure of the stylized synthetic image.

A conventional image generation model may employ an image generation process that is conditioned on an input that describes content of and a style for a synthetic image. However, some styles do not appear frequently in image generation model training data, and therefore conventional image generation models fail to learn the infrequent styles. Furthermore, style information that is used as guidance at each step of an image generation process tends to overwhelm content guidance, resulting in a synthetic image that does not depict the intended content.

One conventional image generation technique attempts to account for infrequent styles in training data by relying on data augmentation and oversampling of training data. However, data augmentation and oversampling require many generative iterations and are therefore expensive and inefficient. Another conventional image generation technique relies on training an image generation model to recognize an optimized text token embedding in order to replicate a specific style. However, this requires both learning a new embedding for each particular style and hand-picking and annotating various styles in a training dataset, and therefore is unscalable and also inefficient and expensive.

Finally, another conventional image generation technique attempts to preserve intended content of a synthetic image by generating a first synthetic image based on an input describing the content and then generating a second synthetic image based on the first synthetic image and style information. However, this technique includes a relatively high amount of latency and is inefficient because it necessitates using at least two full image generation processes to generate every one intended stylized synthetic image.

By contrast, because an image generation model according to aspects of the present disclosure uses style information in a later step or steps of an image generation process, rather than at each step of the image generation process, the structure of the synthetic image is relatively fixed at the earlier steps of the image generation process, and the style information is therefore applied to the synthetic image without altering the structure of the synthetic image. The image generation model therefore produces a stylized synthetic image that accurately reflects both the content information and the style information, without having to be specifically trained on the specific style information. Furthermore, the image generation system according to aspects of the present disclosure is more efficient, scalable, and faster than conventional image generation systems because the image generation system avoids oversampling and data augmentation, training an image generation model to learn new embeddings for each particular style, and using multiple complete image generation processes to generate one stylized image.

According to some aspects, the image generation system obtains a style embedding in a multimodal embedding space based on a style input (such as a text or image prompt) describing style information for the synthetic image. The multimodal embedding space includes semantic information of both the style input and a prompt describing content for the synthetic image, such that the style input and the prompt are more effectively understandable by the image generation model. By generating the synthetic image using the style embedding as guidance, the image generation model is able to better depict the style information described in the style input.

An example aspect of the present disclosure is used in a text-to-image generation context. In the example, a user provides a text prompt “astronaut sitting on a chair” to the image generation system via a user interface provided by the image generation system on a user device. The user selects a style “pencil drawing” from a style list presented in a user interface. The image generation system encodes the text prompt using a text encoder to obtain a text embedding and encodes the text prompt concatenated with a style input including the words “pencil drawing” using a style encoder to obtain a style embedding.

The image generation system generates a synthetic image based on the text embedding and the style embedding using the image generation model by providing the text embedding as an input to the image generation model during initial iterations of an image generation process and providing both the text embedding and the style embedding as inputs to the image generation model during subsequent iterations of the image generation process. Therefore, the image generation model generates an image that depicts an astronaut sitting on a chair, with an appearance of being drawn by with a pencil. The image generation system then provides the synthetic image to the user via the user interface.

The image generation system may also be used to generate a synthetic image based on an image input, where the image input depicts content and structure for the synthetic image. For example, the user may provide an image depicting an astronaut sitting in a chair in a particular manner, and may provide a style input (such as text or an image) indicating style information for the synthetic image. Because the image generation system generates the synthetic image using the style information at a later iteration of an image generation process, the synthetic image retains the structure of the input image (the same astronaut sitting in the same chair in the same particular manner), but stylized according to the style information.

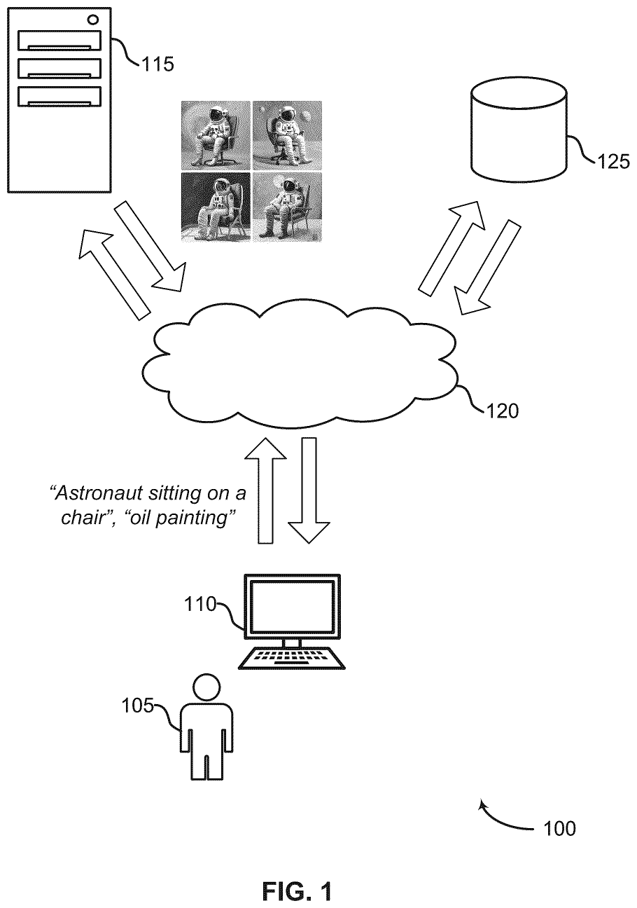

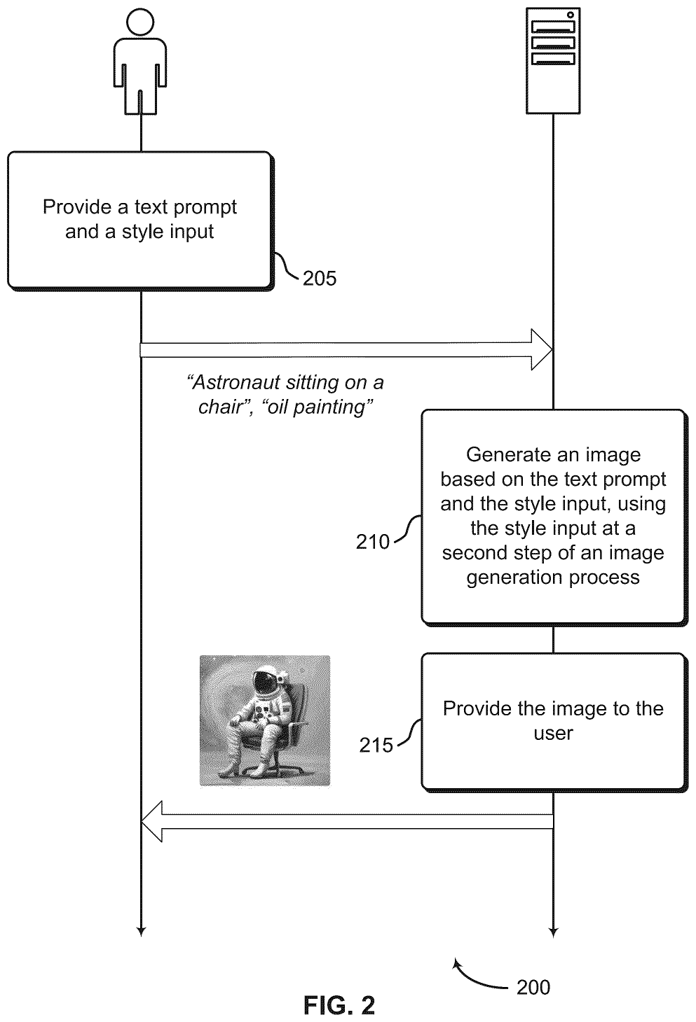

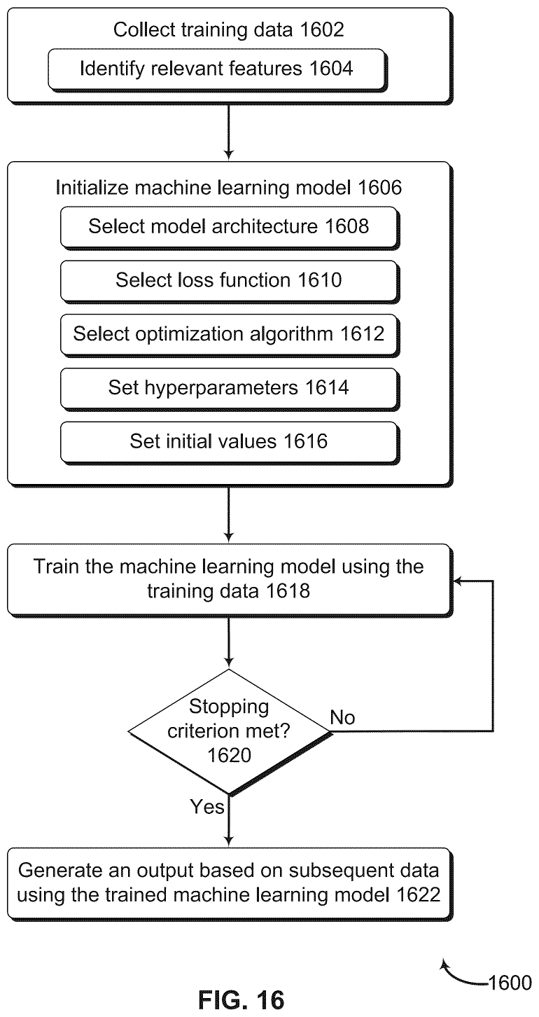

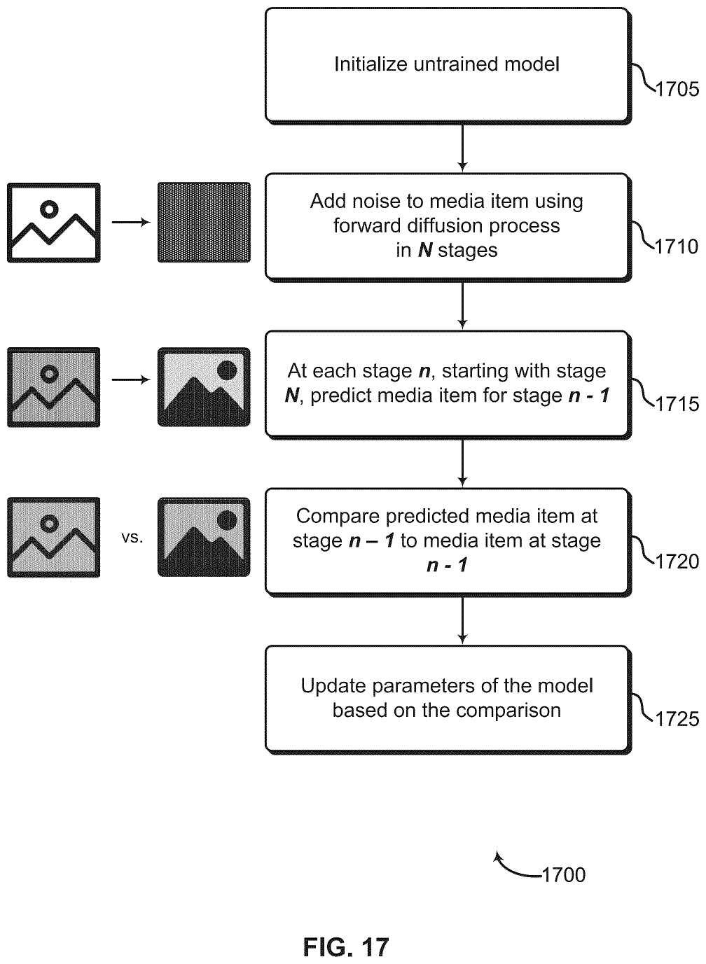

Further example applications of the present disclosure in the image generation context are provided with reference to FIGS. 1-4 and 11-12. Details regarding the architecture of the image generation system are provided with reference to FIGS. 1-10 and 18-20. Examples of a process for image generation are provided with reference to FIGS. 2 and 11-15. Examples of a process for training an image generation model are provided with reference to FIGS. 16-17.

Embodiments of the present disclosure improve upon conventional image generation systems by efficiently generating a stylized synthetic image that accurately reflects both an intended content/structure for the stylized synthetic image and style information for the stylized synthetic image. For example, according to aspects of the present disclosure, an image generation model of an image generation system generates a synthetic image using an image generation process that takes content information as input at an earlier step and both content information and style information as input at a later step. Because the image generation model generates the synthetic image using the style information at the later step, rather than the earlier step, the content/structure of the synthetic image is mostly set before the style information is introduced, and therefore the synthetic image retains the intended content/structure of the synthetic image while being stylized according to the style information.

For example, some conventional image generation processes use style information at every step of an image generation process for generating a stylized synthetic image, such that the style information overwhelms an intended content/structure for the stylized synthetic image. By contrast, the image generation system according to aspects of the present disclosure generates stylized synthetic images that accurately depict both intended content/structure and intended style.

Furthermore, some conventional image generation systems inefficiently rely on data augmentation and oversampling of training data, or training an image generation model to recognize an optimized text token embedding in order to replicate a specific style, or generating a first synthetic image based only on content information using an entire image generation process, and then generating a second synthetic image based on style information and the first synthetic image. By contrast, the image generation system according to aspects of the present disclosure avoids data augmentation and oversampling, token-recognition training, and using multiple full image generation processes, and is therefore more efficient than conventional image generation systems using conventional image generation processes.

### Image Generation System

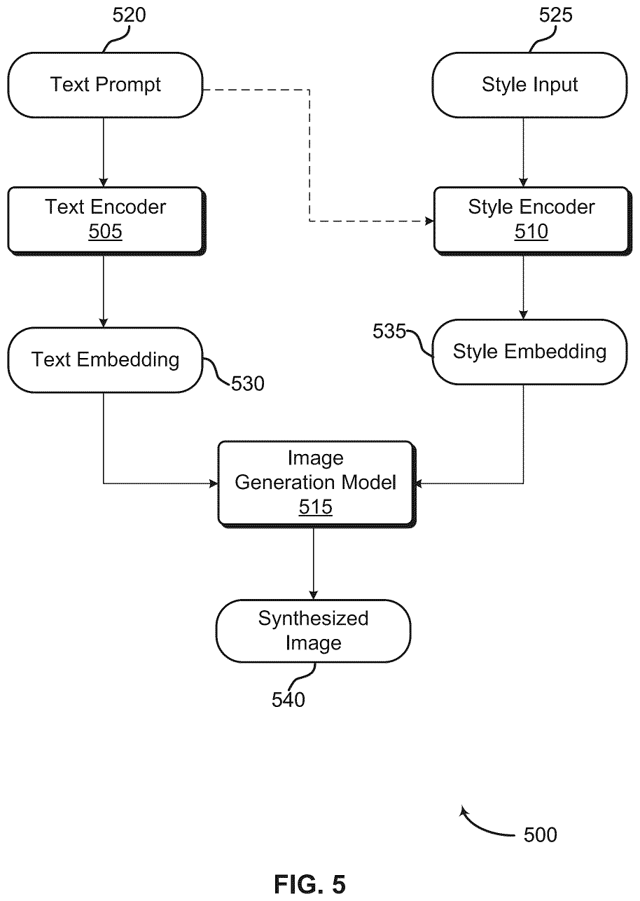

FIG. 1 shows an example of an image generation system 100 according to aspects of the present disclosure. The example shown includes image generation system 100, user 105, user device 110, image generation apparatus 115, cloud 120, and database 125. Image generation system 100 is an example of, or includes aspects of, the corresponding element described with reference to FIG. 5.

Referring to FIG. 1, user 105 provides a text prompt “Astronaut sitting on a chair” and a style input “oil painting” to image generation apparatus 115 via a user interface provided on user device 110 by image generation apparatus 115. Image generation apparatus 115 generates a set of images having content determined by the text prompt with a style determined by the style input. Image generation apparatus 115 provides the set of images to user 105 via the user interface.

A “text prompt” refers to text that describes intended content of an image to be generated by a machine learning model.

An “embedding” refers to a mathematical representation of an input in a lower-dimensional space such that information about the input is more easily captured and analyzed by the machine learning model. For example, an embedding may be a numerical representation of the input in a continuous vector space (e.g., an embedding space) in which objects that have similar semantic information correspond to vectors that are numerically similar to and thus “closer” to each other, allowing machine learning model to effectively compare different objects corresponding to different embeddings with each other.

For example, a text embedding space includes vector representations in which text embeddings are numerically similar to each other, and an image embedding space includes vector representations in which image embeddings are numerically similar to each other. A multimodal embedding space includes vector representations of multiple modalities (such as a text modality and an image modality) in which vector representations of the multiple modalities are numerically similar to each other, allowing different objects from different modalities to be effectively compared with each other.

“Content” refers to an object (for example, “an astronaut”) that is depicted in an image or is intended to be depicted in a synthetic image. Content may be described via text or an image.

A “style input” refers to a representation of information that describes an intended modification of an appearance of content of an image. A style input may include text, an image, or a combination thereof. For example, a style input including the text “oil painting” should cause a synthetic image generated based on the style input to appear to be done in an oil painting style.

A “synthetic image” or a “synthesized image” refers to an image generated by a machine learning model.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image generation apparatus 115. In some aspects, the user interface allows information (such as an image, a prompt, user inputs, etc.) to be communicated between user 105 and image generation apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). The user device user interface may be a graphical user interface.

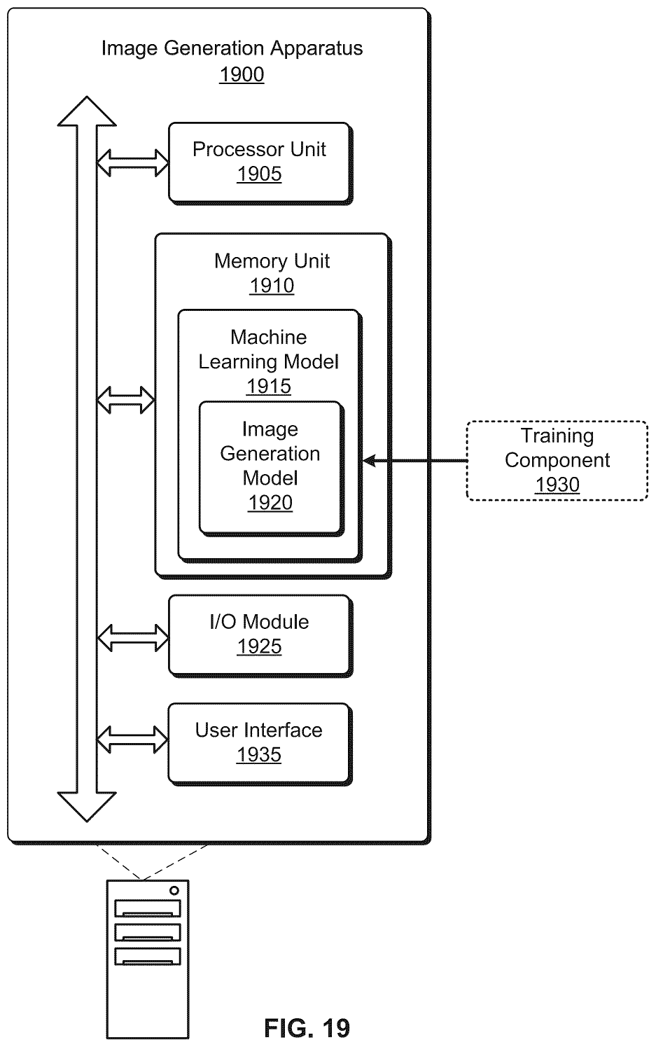

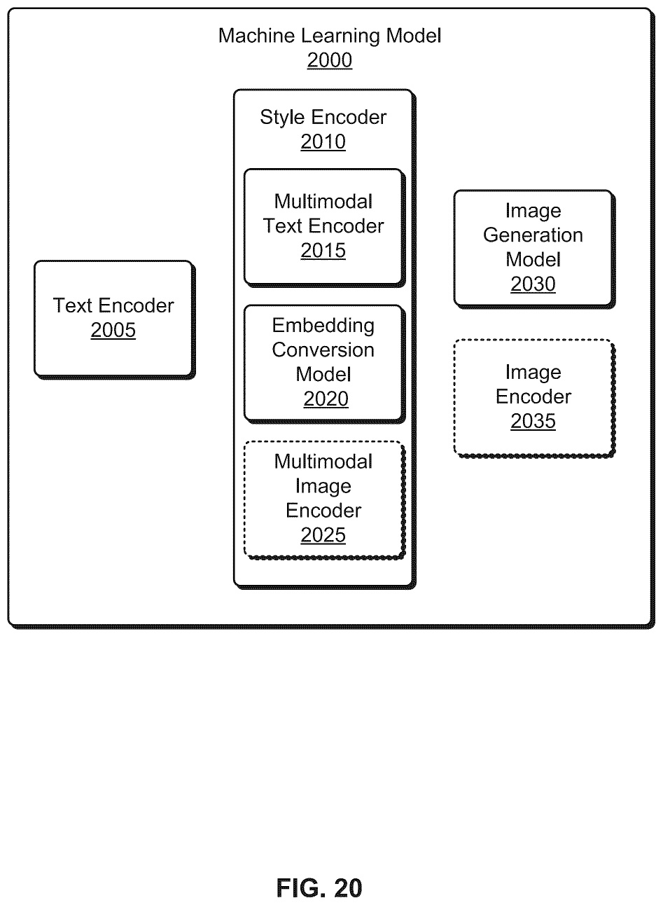

According to some aspects, image generation apparatus 115 includes a computer-implemented network. In some embodiments, the computer-implemented network includes a machine learning model (such as the machine learning model described with reference to FIGS. 19 and 20). In some embodiments, image generation apparatus 115 also includes one or more processors, a memory subsystem, a communication interface, an I/O interface, one or more user interface components, and a bus as described with reference to FIG. 17. Additionally, in some embodiments, image generation apparatus 115 communicates with user device 110 and database 125 via cloud 120.

Image generation apparatus 115 may be implemented on a server. A server provides one or more functions to users linked by way of one or more of various networks, such as cloud 120. The server may include a single microprocessor board that includes a microprocessor responsible for controlling all aspects of the server. The server may use the microprocessor and protocols such as hypertext transfer protocol (HTTP), simple mail transfer protocol (SMTP), file transfer protocol (FTP), simple network management protocol (SNMP), and the like to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Image generation apparatus 115 is an example of, or includes aspects of, the corresponding element described with reference to FIG. 19. Further detail regarding the architecture of image generation apparatus 115 is provided with reference to FIGS. 2-10 and 18-20. Further detail regarding a process for image generation is provided with reference to FIGS. 2 and 11-15. Examples of a process for training an image generation model are provided with reference to FIGS. 16-17.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some examples, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, image generation apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller or the database controller may operate automatically without interaction from the user. According to some aspects, database 125 is external to image generation apparatus 115 and communicates with image generation apparatus 115 via cloud 120. According to some aspects, database 125 is included in image generation apparatus 115.

FIG. 2 shows an example of a method 200 for generating an image according to aspects of the present disclosure. In the example of FIG. 2, a user provides a text prompt “Astronaut sitting on a chair” and a style input “oil painting” to the image generation system. The image generation system generates a synthetic image based on the text prompt and the style input by conditioning earlier steps of an image generation process only on the text prompt and conditioning the following steps of the image generation process on both the text prompt and the style input. Therefore, the content of the synthetic image is mostly set before the style information can disrupt it, and the synthetic image accurately depicts an astronaut sitting on a chair, with an appearance of an oil painting. The image generation system then provides the synthetic image to the user via the user interface.

At operation 205, a user provides a text prompt and a style input. In some cases, the operations of this step refer to, or may be performed by, a user as described with reference to FIG. 1. In an example, the user provides the text prompt via a user interface displayed on a user device (such as the user device described with reference to FIG. 1) by an image generation apparatus (such as the image generation apparatus described with reference to FIGS. 1 and 19). The user provides the style input as a text input to the user interface. The user selects a style from the user interface, and the image generation apparatus identifies a style input including text corresponding to the selected style (for example, by retrieving text corresponding to the selected style from a database, or generating text corresponding to the selected style).

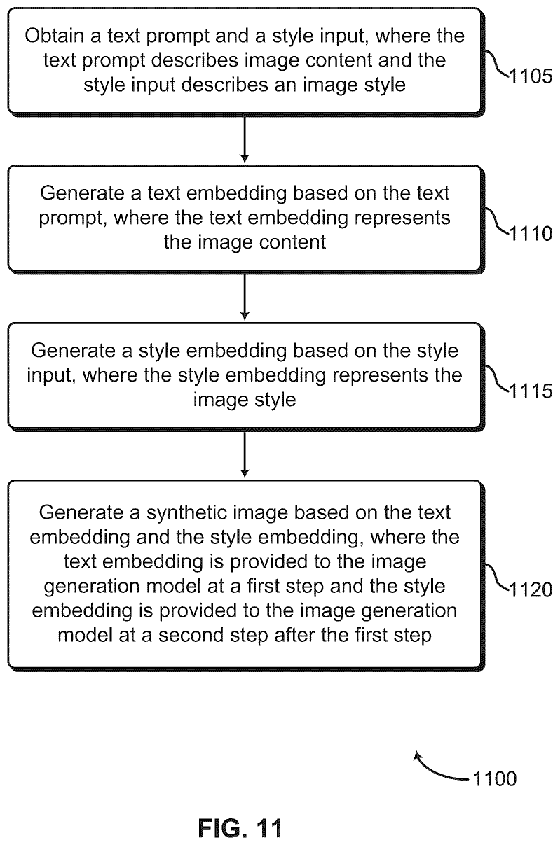

At operation 210, the system generates an image based on the text prompt and the style input, using the style input at a second step of an image generation process. In some cases, the operations of this step refer to, or may be performed by, an image generation apparatus as described with reference to FIGS. 1 and 19. For example, the image generation apparatus may generate the image using an image generation model as described with reference to FIGS. 11-15.

At operation 215, the system provides the image to the user. In some cases, the operations of this step refer to, or may be performed by, an image generation apparatus as described with reference to FIGS. 1 and 19. In an example, the image generation apparatus displays the image to the user via the user interface.

In some aspects, embodiments of the disclosure include obtaining an image input and a style input, wherein the image input depicts image content and the style input describes an image style; generating, using an image generation model, a first intermediate output based on the content input during a first stage of a diffusion process; generating, using the image generation model, a second intermediate output based on the first intermediate output and the style input during a second stage of the diffusion process; and generating, using the image generation model, a synthetic image based on the second intermediate output, wherein the style embedding is provided at a second step of generating the synthetic image after a first step

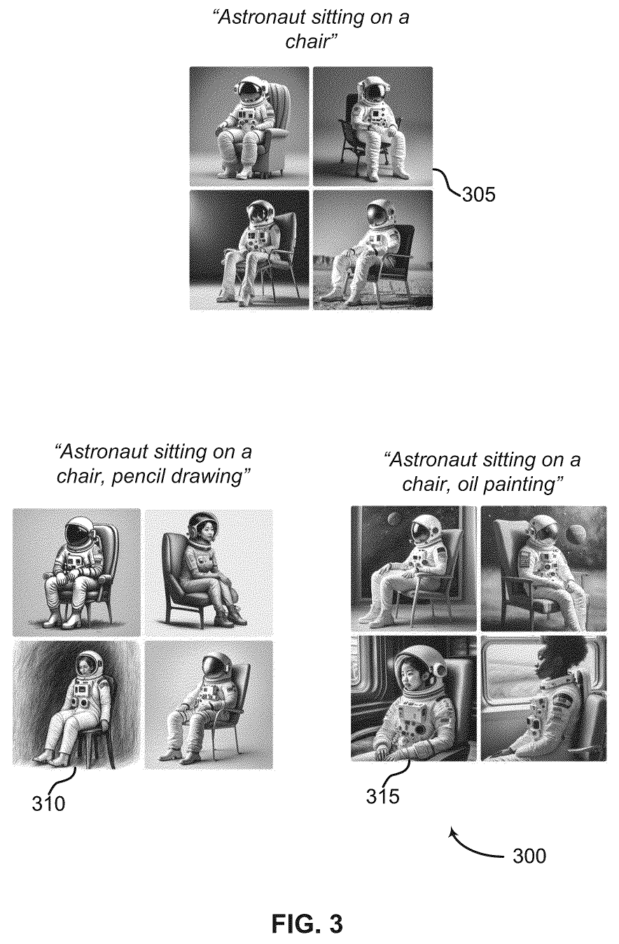

FIG. 3 shows an example 300 of comparative generated images according to aspects of the present disclosure. The example shown includes first set of comparative images 305, second set of comparative images 310, and third set of comparative images 315.

Referring to FIG. 3, first set of comparative images 305 is generated by an image generation model (e.g., the image generation model described with reference to FIGS. 5, 19, and 20) based on a text prompt “Astronaut sitting on a chair”, where the text prompt does not include style information. Second set of comparative images 310 is generated by the image generation model based on a text prompt “Astronaut sitting on a chair, pencil drawing”, where “pencil drawing” is intended as style information. However, because the second set of comparative images 310 is generated using one text prompt input as guidance, rather than a separate content input describing content information and a style input describing style information, the intended “pencil drawing” style is not consistently apparent in each of the second set of comparative images 310.

Third set of comparative images 315 is generated by the image generation model based on a text prompt “Astronaut sitting on a chair, oil painting”, where “oil painting” is intended as style information. In the example, correspondingly located images of first set of comparative images 305 and third set of comparative images 315 (e.g., top-left, top-right, bottom-left, bottom-right) are generated based on a same seed, and so the only difference between the corresponding images should relate to the style information. However, because the style information is provided as guidance at each step of an image generation process used to generate third set of comparative images 315, structures of images of third set of comparative images 315 differ from corresponding images of first set of comparative images 305.

For example, the bottom-left image of third set of comparative images 315 includes an illustrated face and a wooden-armed chair, the chair and the astronaut are partially obscured by a bottom boundary of the image, and the image depicts a window. By contrast, the corresponding bottom-left image of first set of comparative images 305 includes an illustration of a closed helmet and a metal-armed chair, the chair and the astronaut are not obscured by a bottom boundary of the image, the astronaut is posed differently in the image, and the image does not depict a window. Therefore, the style information present in the text prompt has unintentionally and undesirably affected the structures of third set of comparative images 315.

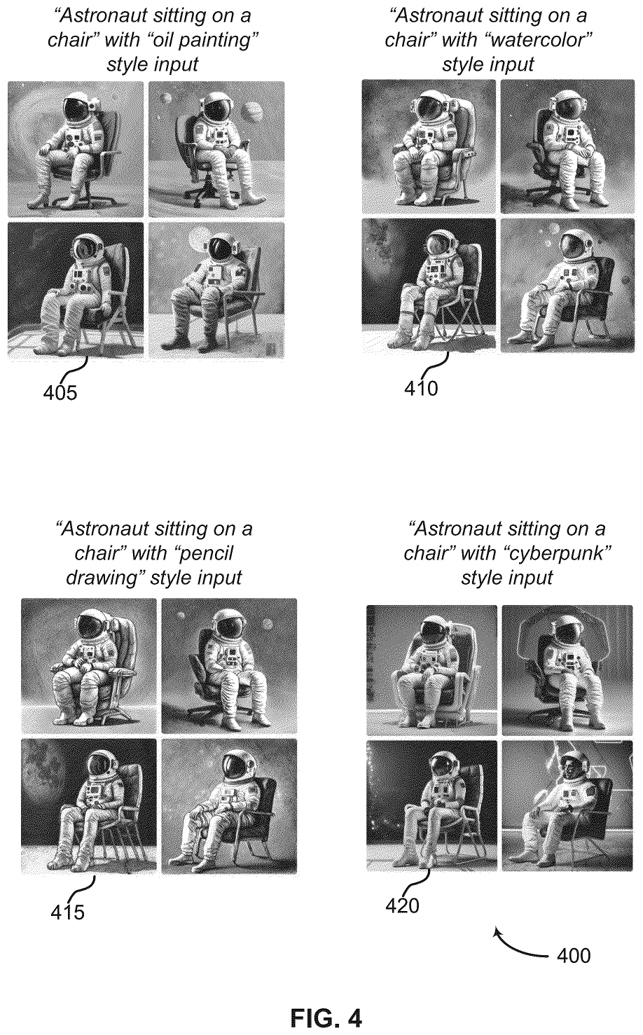

FIG. 4 shows a first example 400 of synthetic images according to aspects of the present disclosure. The example shown includes first set of synthetic images 405, second set of synthetic images 410, third set of synthetic images 415, and fourth set of synthetic images 420.

Referring to FIGS. 3 and 4, each of first set of synthetic images 405, second set of synthetic images 410, third set of synthetic images 415, and fourth set of synthetic images 420 are generated by the image generation model based on a same text prompt (“Astronaut sitting on a chair”) as the first set of comparative images 305 described with reference to FIG. 3. Furthermore, correspondingly located images of first set of synthetic images 405, second set of synthetic images 410, third set of synthetic images 415, fourth set of synthetic images 420, and the first set of comparative images 305 described with reference to FIG. 3 are generated based on a common seed, and so the correspondingly located images should appear to be structurally similar.

Referring to FIG. 4, first set of synthetic images 405 are also generated based on a style embedding derived from an “oil painting” style input, where the style embedding is provided as input to the image generation model during a later step of an image generation process. Therefore, the “oil painting” style is consistently apparent in each of the first set of synthetic images 405. Furthermore, the first set of synthetic images 405 is structurally consistent with the first set of comparative images 305 described with reference to FIG. 3. Second set of synthetic images 410, third set of synthetic images 415, and fourth set of synthetic images 420 are similarly consistently stylized according to their respective style inputs, and are structurally consistent with the first set of comparative images 305 described with reference to FIG. 3.

FIG. 5 shows an example of data flow in an image generation system 500 according to aspects of the present disclosure. The example shown includes image generation system 500, text prompt 520, style input 525, text embedding 530, style embedding 535, and synthetic image 540. In one aspect, image generation system 500 includes text encoder 505, style encoder 510, and image generation model 515.

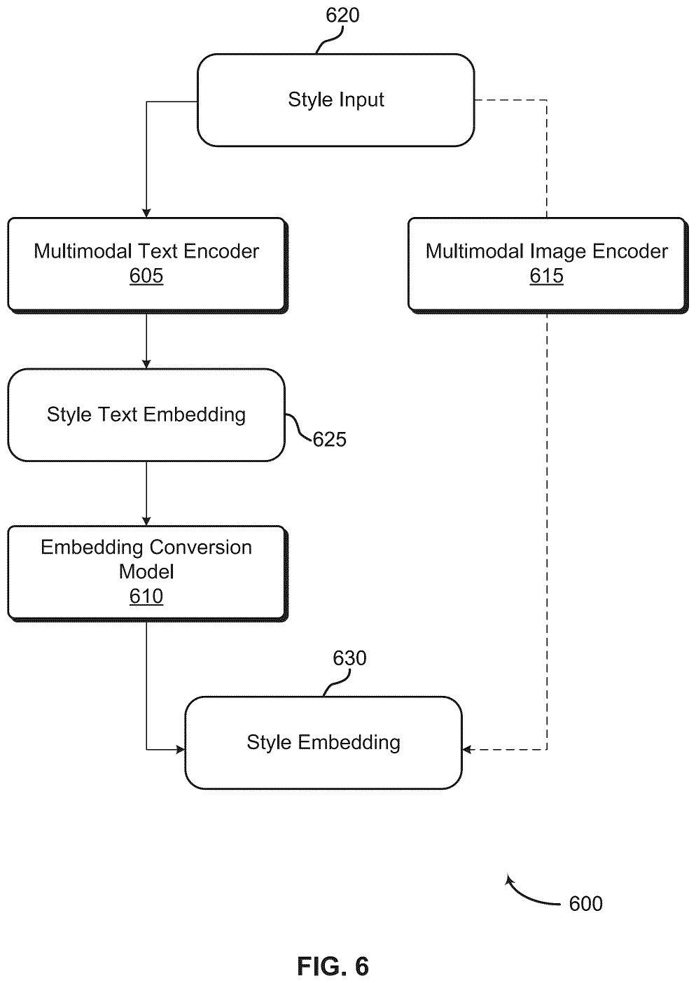

Referring to FIG. 5, according to some aspects, text encoder 505 receives text prompt 520 and outputs text embedding 530 in response. According to some aspects, style encoder 510 receives style input 525 and outputs style embedding 535 in response. In some embodiments, as indicated by the dotted line, style encoder also generates style embedding 535 based on text prompt 520. In an example, text prompt 520 and style input 525 are concatenated and separated with a comma, and style encoder 510 generates style embedding 535 based on the concatenated text prompt 520 and style input 525. A data flow in style encoder 510 is described in further detail with reference to FIG. 6. According to some aspects, image generation model 515 generates synthetic image 540 based on text embedding 530 and style embedding 535.

Image generation system 500 is an example of, or includes aspects of, the corresponding element described with reference to FIG. 1. Text encoder 505 is an example of, or includes aspects of, the corresponding element described with reference to FIG. 20. Style encoder 510 is an example of, or includes aspects of, the corresponding element described with reference to FIGS. 6 and 20. Image generation model 515 is an example of, or includes aspects of, the corresponding element described with reference to FIGS. 19 and 20. Style input 525 and style embedding 535 are examples of, or include aspects of, the corresponding elements described with reference to FIG. 6.

FIG. 6 shows an example of data flow in a style encoder 600 according to aspects of the present disclosure. The example shown includes style encoder 600, style input 620, style text embedding 625, and style embedding 630. In one aspect, style encoder 600 includes multimodal text encoder 605, embedding conversion model 610, and multimodal image encoder 615.

Referring to FIG. 6, according to some aspects, multimodal text encoder 605 receives style input 620 as input, where style input 620 comprises text, and generates style text embedding 625 in response. According to some aspects, embedding conversion model 610 generates style embedding 630 based on style text embedding 625.

Alternatively, according to some aspects, multimodal image encoder 615 receives style input 620, where style input 620 comprises an image, and generates style embedding 630 based on style input 620.

Style encoder 600 is an example of, or includes aspects of, the corresponding element described with reference to FIGS. 5 and 20. Multimodal text encoder 605, embedding conversion model 610, and multimodal image encoder 615 are examples of, or include aspects of, the corresponding elements described with reference to FIG. 20. Style input 620 and style embedding 630 are examples of, or include aspects of, the corresponding elements described with reference to FIG. 5.

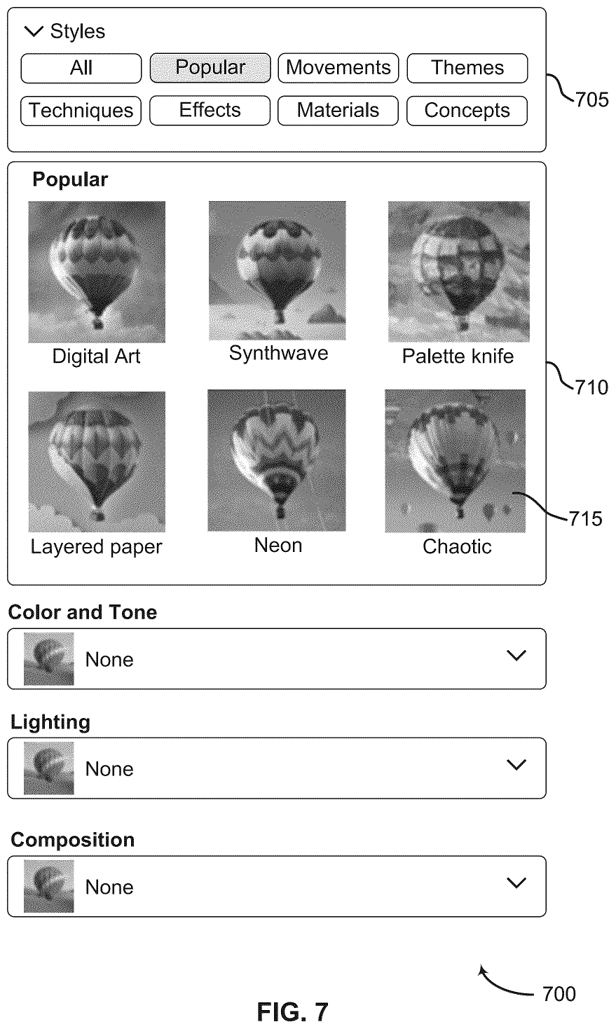

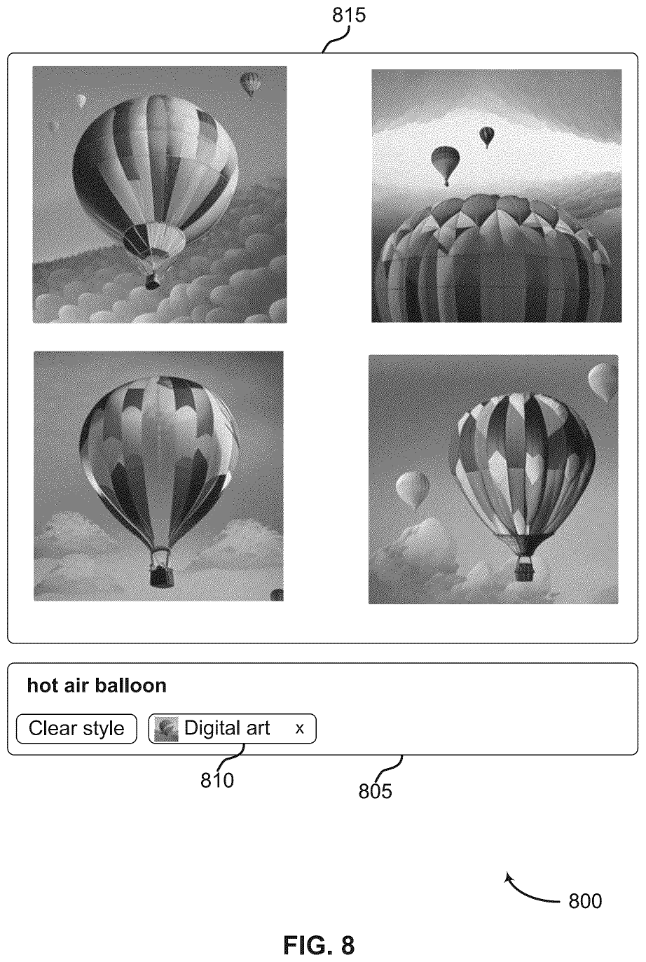

FIG. 7 shows an example of a user interface 700 for providing a style input according to aspects of the present disclosure. User interface 700 is an example of, or includes aspects of, the corresponding element described with reference to FIGS. 8 and 19. In one aspect, user interface 700 includes style group selection element 705 and style selection element 710. In one aspect, style selection element 710 includes style preview image 715.

Referring to FIG. 7, according to some aspects, an image generation apparatus (such as the image generation apparatus described with reference to FIGS. 1 and 19) obtains style information for a style input described herein via user interface 700. For example, as shown in FIG. 7, a user (such as the user described with reference to FIG. 1) can select from a group of predetermined styles using style group selection element 705, and select a style from the group of predetermined styles using style selection element 710. In the example of FIG. 7, in response to a user selection of a “popular” group of predetermined styles, style selection element 710 displays predetermined styles “Digital art”, “Synthwave”, “Palette knife”, “Layered paper”, “Neon”, and “Chaotic” included in the group.

The image generation apparatus retrieves a style input including text corresponding to the style (for example, from a database such as the database described with reference to FIG. 1) or generates text for the style input based on the selected style. Style selection element 710 displays a set of preview images corresponding to the group of predetermined styles. Style preview image 715 is an example representation of a “Chaotic” stylization of an image.

FIG. 8 shows an example of a user interface 800 for displaying synthetic images according to aspects of the present disclosure. User interface 800 is an example of, or includes aspects of, the corresponding element described with reference to FIGS. 7 and 19. In one aspect, user interface 800 includes text prompt element 805, selected style element 810, and synthetic images element 815.

Referring to FIG. 8, according to some aspects, user interface 800 displays synthetic images in synthetic images element 815 that have been generated based on the text prompt displayed in text prompt element 805 and a style input corresponding to the style represented in selected style element 810. In the example of FIG. 8, synthetic images element 815 displays images generated based on a text prompt “hot air balloon” and a “Digital art” style input.

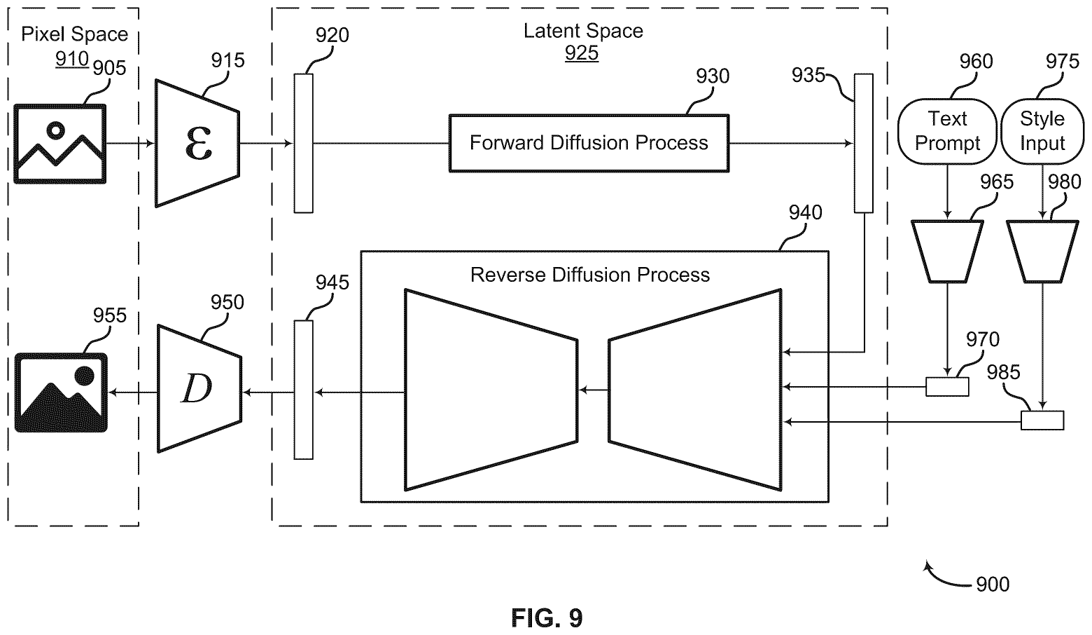

FIG. 9 shows an example of a guided diffusion model 900 according to aspects of the present disclosure. In some examples, guided diffusion model 900 describes the operation and architecture of the image generation model 1920 described with reference to FIG. 19. The guided diffusion model 900 depicted in FIG. 9 is an example of, or includes aspects of, an image generation model as described herein.

Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, or to image features generated by an encoder, as in latent diffusion.

For example, according to some aspects, image encoder 915 (such as the image encoder described with reference to FIG. 20) encodes original image 905 from pixel space 910 and generates original image features 920 in latent space 925. According to some aspects, original image 905 is an image input as described herein, a separate image from the input image described herein, or a training image as described with reference to FIG. 17. According to some aspects, original image features 920 are an image embedding as described herein.

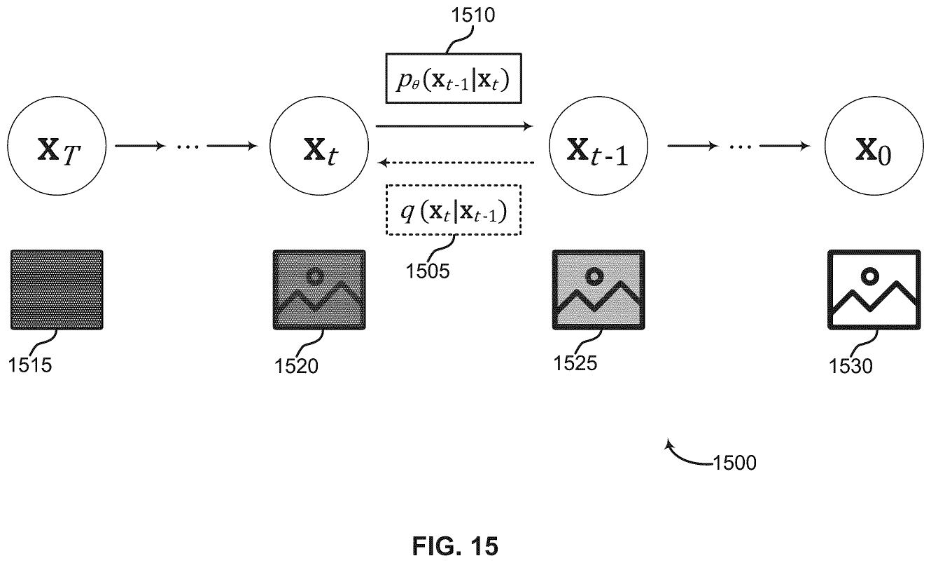

According to some aspects, forward diffusion process 930 gradually adds noise to original image features 920 to obtain noisy features 935 (also in latent space 925) at various noise levels. Forward diffusion process 930 may be implemented as the forward diffusion process described with reference to FIG. 15 or 17. Forward diffusion process 930 may be implemented by an image generation apparatus (such as the image generation apparatus described with reference to FIGS. 1 and 19) or by a training component (such as the training component described with reference to FIG. 19).

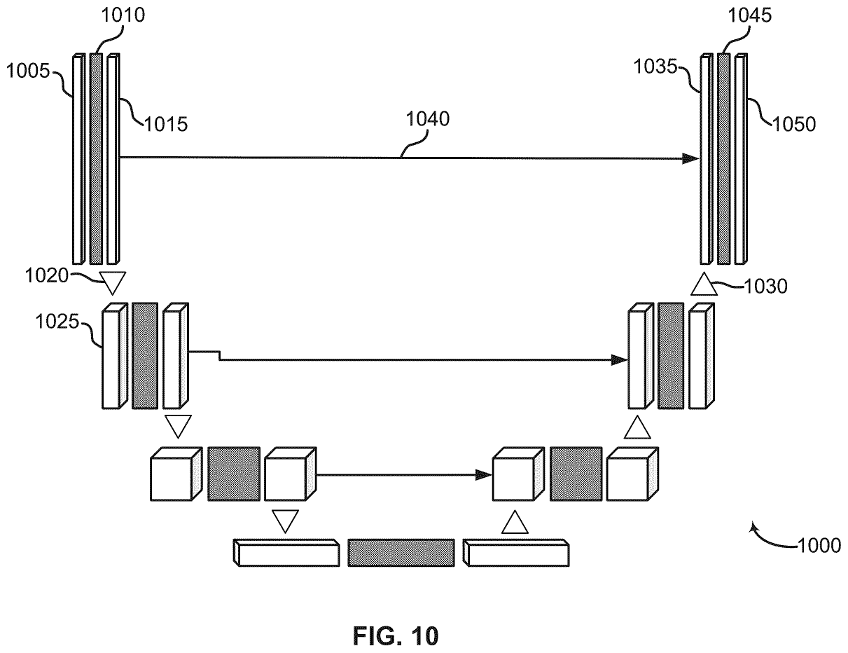

According to some aspects, reverse diffusion process 940 is applied to noisy features 935 to gradually remove the noise from noisy features 935 at the various noise levels to obtain denoised image features 945 in latent space 925. Reverse diffusion process 940 may be implemented as the reverse diffusion process described with reference to FIG. 15 or 17. Reverse diffusion process 940 may be implemented by an image generation model described with reference to FIGS. 5, 19, and 20. Reverse diffusion process 940 may be implemented by a U-Net ANN described with reference to FIG. 10 included in the image generation model.

According to some aspects, a training component (such as the training component described with reference to FIG. 19) compares denoised image features 945 to original image features 920 at each of the various noise levels, and updates image generation parameters of the image generation model based on the comparison. Image decoder 950 decodes denoised image features 945 to obtain output image 955 in pixel space 910. An output image 955 may be created at each of the various noise levels. The training component may compare output image 955 to original image 905 to train the image generation model. Output image 955 is a synthetic image as described herein.

Image encoder 915 and image decoder 950 may be pretrained prior to training the image generation model. Image encoder 915, image decoder 950, and the image generation model may be jointly trained. Image encoder 915 and image decoder 950 may be jointly fine-tuned with the image generation model.

According to some aspects, reverse diffusion process 940 is guided based on text prompt 960 (e.g., a text prompt as described herein) and by style input 975 (e.g., a style input as described herein). Text prompt 960 is encoded using text encoder 965 (e.g., a text encoder as described with reference to FIGS. 5 and 20) to obtain text embedding 970 (e.g., a text embedding as described herein). Style input 975 is encoded using style encoder 980 (e.g., a style encoder as described with reference to FIGS. 5, 6, and 20) to obtain style embedding 985 (e.g., a style embedding as described herein).

Text embedding 970 may be combined with noisy features 935 at one or more layers of reverse diffusion process 940 at each diffusion step of reverse diffusion process 940 to encourage output image 955 to include content described by text prompt 960. Style embedding 985 may be combined with noisy features 935 at one or more layers of reverse diffusion process 940 at a second step following a first step of reverse diffusion process 940 to encourage output image 955 to be stylized according to style input 975.

Text embedding 970 and style embedding 985 may be combined with noisy features 935 using a cross-attention block within reverse diffusion process 940. Cross-attention, also known as multi-head attention, is an extension of the attention mechanism used in some ANNs for NLP tasks. Cross-attention enables reverse diffusion process 940 to attend to multiple parts of an input sequence simultaneously, capturing interactions and dependencies between different elements.

In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 940 to better understand the context and generate more accurate and contextually relevant outputs.

According to some aspects, image encoder 915 and image decoder 950 are omitted, and forward diffusion process 930 and reverse diffusion process 940 occur in pixel space 910. In an example, forward diffusion process 930 adds noise to original image 905 to obtain noisy images in pixel space 910, and reverse diffusion process 940 gradually removes noise from the noisy images to obtain output image 955 in pixel space 910.

FIG. 10 shows an example of a U-Net 1000 according to aspects of the present disclosure. In some examples, U-Net 1000 is an example of the component that performs the reverse diffusion process 940 of guided diffusion model 900 described with reference to FIG. 9 and includes architectural elements of the image generation model 1920 described with reference to FIG. 19. The U-Net 1000 depicted in FIG. 10 is an example of, or includes aspects of, the architecture used within the reverse diffusion process described with reference to FIG. 9.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having a same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

### Image Generation

Methods for image generation using machine learning are described with reference to FIGS. 11-15. FIG. 11 shows an example of a method 1100 for generating a synthetic image based on a text prompt according to aspects of the present disclosure.

Referring to FIG. 11, according to some aspects, a synthetic image is generated based on style information included in a style input, where the style information helps to determine an appearance of the image. In some cases, the style information is used to inform a later step or steps of an image generation process. In some cases, by using the style information in the later step or steps, rather than each step of the image generation process, the style information is caused to be consistently apparent in the output. In some cases, by using the style information in the later step or steps, rather than each step of the image generation process, the style information does not overwhelm other information used for generating the image (such as a text prompt), and an intended structure of the image provided by the other information is maintained in the image.

At operation 1105, the system obtains a text prompt and a style input, where the text prompt describes image content and the style input describes an image style. In some cases, the operations of this step refer to, or may be performed by, a user interface as described with reference to FIGS. 7, 8, and 19.

According to some aspects, a user (such as the user described with reference to FIG. 1) provides the text prompt to the image generation apparatus via the user interface displayed on a user device (such as the user device described with reference to FIG. 1) by the image generation apparatus.

According to some aspects, a user provides the style input to the image generation apparatus via the user interface. In some embodiments, the style input includes text. In some embodiments, the style input includes an image. In some embodiments, the user selects a style from a set of predetermined styles via the user interface, and the image generation apparatus retrieves a style input including text associated with the selected style (for example, from a database, such as the database described with reference to FIG. 1).

According to some aspects, the image generation apparatus extracts the text prompt and the style input from a user input. For example, in some embodiments, the user provides a single text input including both the text prompt and the style input. The image generation apparatus identifies the text prompt and the style input in the single text input and extracts the identified text prompt and the identified style input based on the identification.

According to some aspects, the image generation apparatus provides a set of predetermined styles and receives a user input selecting at least one of the plurality of predetermined styles to obtain the style input. For example, in some embodiments, the image generation apparatus displays a set of text describing the predetermined styles, or a set of images depicting examples of the predetermined styles.

According to some aspects, the image generation apparatus generates the style input based on a style image. In an example, a user provides the style image to the user interface, and an image generation model (such as the image generation model described with reference to FIGS. 5, 19, and 20) generates an image comprising the style input based on the style image, or a text description comprising the style input, where the text description describes a style of the style image.

According to some aspects, obtaining the style input includes displaying a set of preview images corresponding to the set of predetermined styles, respectively. For example, in some embodiments, the image generation apparats displays a set of preview synthetic images generated according to each of the set of predetermined styles, and the user can select the style input from among the set of predetermined styles corresponding to the set of preview synthetic images.

At operation 1110, the system generates a text embedding based on the text prompt, where the text embedding represents the image content. In some cases, the operations of this step refer to, or may be performed by, a text encoder as described with reference to FIGS. 5 and 20.

At operation 1115, the system generates a style embedding based on the style input, where the style embedding represents the image style. In some cases, the operations of this step refer to, or may be performed by, a style encoder as described with reference to FIGS. 5, 6, and 20.

According to some aspects, where the style input includes text, a multimodal text encoder (such as the multimodal text encoder described with reference to FIGS. 6 and 20) encodes a concatenation of the text prompt and the style input in which the text prompt and style input are separated from each other by a comma to obtain a style text embedding. In some cases, the style text embedding is obtained in a multimodal embedding space.

In some embodiments, an embedding conversion model (such as the embedding conversion model described with reference to FIGS. 6 and 20) converts or maps the style text embedding to the style embedding. By converting the style text embedding to the style embedding, the embedding conversion model maps textual semantics to corresponding visual semantics that are more effectively used by the image generation model.

According to some aspects, where the style input includes an image, a multimodal image encoder (such as the multimodal image encoder described with reference to FIGS. 6 and 20) encodes the style input to obtain the style embedding.

The style embedding effectively captures the style information included in the style input. In some embodiments, the style embedding is obtained in the multimodal embedding space. In some embodiments, the style embedding is an image embedding including image semantic features corresponding to the semantic features of the text prompt and the style input.

At operation 1120, the system generates a synthetic image based on the text embedding and the style embedding, where the text embedding is provided to the image generation model at a first step and the style embedding is provided to the image generation model at a second step after the first step. In some cases, the operations of this step refer to, or may be performed by, an image generation model as described with reference to FIGS. 5, 19, and 20.

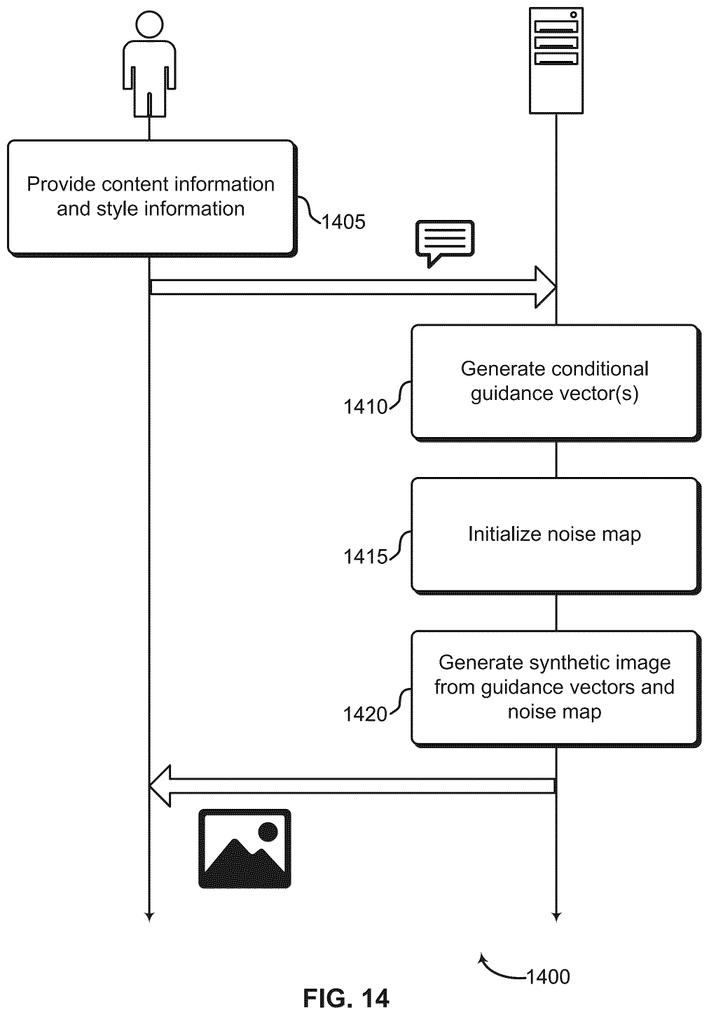

According to some aspects, the image generation model performs a reverse diffusion process (such as the reverse diffusion process described with reference to FIGS. 14-15) including a plurality of diffusion time steps to obtain the synthetic image. In some embodiments, the text embedding is provided to the image generation model during a first portion of the plurality of diffusion time steps, and both the text embedding and the style embedding are provided to the image generation model during a second portion of the plurality of diffusion time steps following the first portion. In some embodiments, the style embedding is not provided to the image generation model during the first portion of the plurality of diffusion time steps. For example, in some embodiments, the image generation model is provided with the text embedding as guidance conditioning at a first 10% to 20% of the diffusion time steps, and the image generation model is provided with both the text embedding and the style embedding as guidance conditioning at the remaining 90% to 80% of the diffusion time steps, respectively.

According to some aspects, the image generation apparatus displays the synthetic image to the user via the user interface.

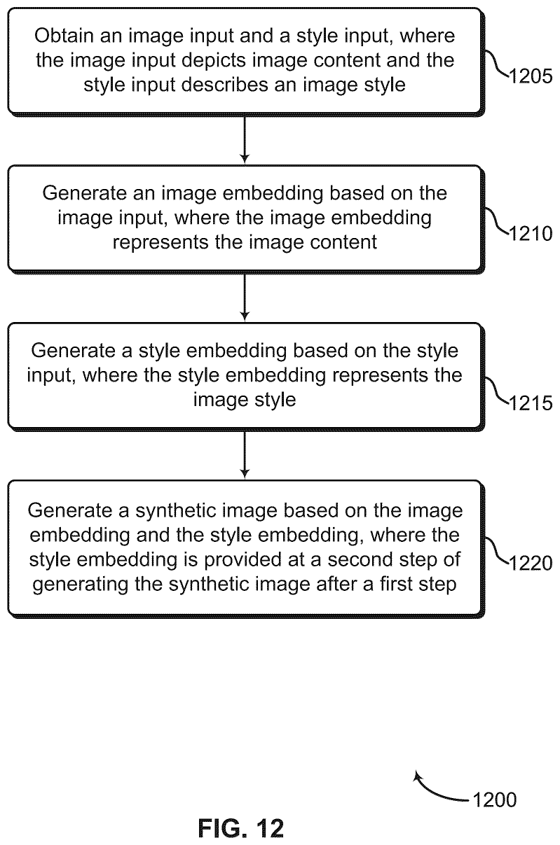

FIG. 12 shows an example of a method 1200 for generating a synthetic image based on an image according to aspects of the present disclosure. Referring to FIG. 12, according to some aspects, a user provides an image input (e.g., an image) to an image generation apparatus (such as the image generation apparatus described with reference to FIGS. 1 and 19) to be stylized according to a style input as described herein. Therefore, in some cases, the image generation apparatus allows a user to consistently generate a stylized synthetic image based on the input image while retaining a structure of the input image in the stylized synthetic image.

At operation 1205, the system obtains an image input and a style input, where the image input depicts image content and the style input describes an image style. In some cases, the operations of this step refer to, or may be performed by, a user interface as described with reference to FIGS. 7, 8, and 19. In an example, the user provides the input image to the image generation apparatus via the user interface.

At operation 1210, the system generates an image embedding based on the image input, where the image embedding represents the image content. In some cases, the operations of this step refer to, or may be performed by, an image encoder as described with reference to FIG. 20.

At operation 1215, the system generates a style embedding based on the style input, where the style embedding represents the image style. In some cases, the operations of this step refer to, or may be performed by, a style encoder as described with reference to FIGS. 5, 6, and 20.

At operation 1220, the system generates a synthetic image based on the image embedding and the style embedding, where the style embedding is provided at a second step of generating the synthetic image after a first step. In some cases, the operations of this step refer to, or may be performed by, an image generation model as described with reference to FIGS. 5, 19, and 20. In an example, the image generation model generates the synthetic image using a reverse diffusion process (such as the reverse diffusion process described with reference to FIGS. 14-15) guided by the image embedding and the style embedding. In some embodiments, the style embedding is provided as an input to the image generation model at a second (e.g., later) diffusion time step of the reverse diffusion process after a first step (e.g., earlier) diffusion time step of the reverse diffusion process. In some embodiments, the style embedding is not provided as an input to the image generation model before the second diffusion time step.

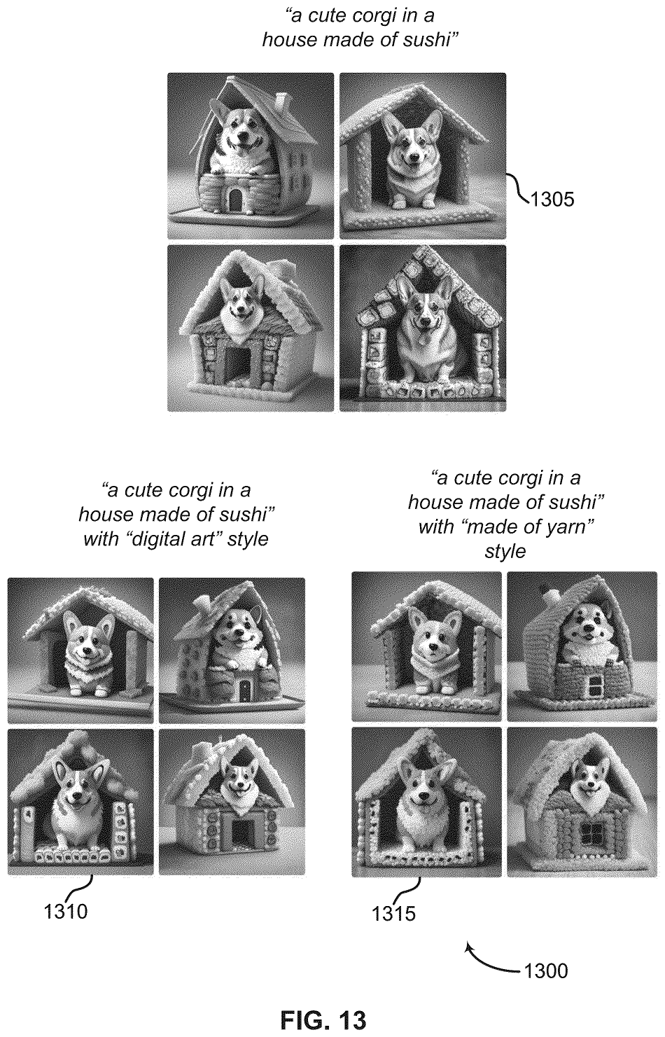

FIG. 13 shows a second example 1300 of synthetic images according to aspects of the present disclosure. The example shown includes fifth set of synthetic images 1305, sixth set of synthetic images 1310, and seventh set of synthetic images 1315.

Referring to FIG. 13, fifth set of synthetic images 1305 are generated by an image generation model (such as the image generation model described with reference to FIGS. 5, 19, and 20) based on a prompt “a cute corgi in a house made of sushi”, and sixth set of synthetic images 1310 and seventh set of synthetic images 1315 are stylized based on respective “digital art” and “made of yarn” style inputs. Similarly to the sets of synthetic images shown in FIG. 4, sixth set of synthetic images 1310 and seventh set of synthetic images 1315 maintain an intended structure and are consistently stylized as intended.

FIG. 14 shows an example of a method 1400 for conditional image generation according to aspects of the present disclosure. In some examples, method 1400 describes an operation of the image generation model 1920 described with reference to FIG. 19 such as an application of the guided diffusion model 900 described with reference to FIG. 9. In some examples, these operations are performed by a system including a processor executing a set of codes to control functional elements of an apparatus such as the image generation model described in FIG. 9.

Additionally or alternatively, steps of the method 1400 may be performed using special-purpose hardware. Generally, these operations are performed according to the methods and processes described in accordance with aspects of the present disclosure. In some cases, the operations described herein are composed of various substeps or are performed in conjunction with other operations.

At operation 1405, a user provides content information and style information for a synthetic image. For example, a user may provide the content information via a text prompt “a person playing with a cat”, and the style information via an additional text prompt “oil painting”. In some examples, guidance can be provided in a form other than text, such as an image, a sketch, or a layout.

At operation 1410, the system converts the content information and style information into conditional guidance vectors or other multi-dimensional representation. For example, text may be converted into a vector or a series of vectors using a transformer model, or a multi-modal encoder. In some cases, the encoder for the conditional guidance is trained independently of the diffusion model.

At operation 1415, a noise map is initialized that includes random noise. The noise map may be in a pixel space or a latent space. By initializing an image with random noise, different variations of an image including the content described by the conditional guidance can be generated.

At operation 1420, the system generates an image based on the noise map and the conditional guidance vector. For example, the image may be generated using a reverse diffusion process as described with reference to FIG. 15.

FIG. 15 shows an example of a diffusion process 1500 according to aspects of the present disclosure. In some examples, diffusion process 1500 describes an operation of the image generation model 1920 described with reference to FIG. 19, such as the reverse diffusion process 940 of guided diffusion model 900 described with reference to FIG. 9.

As described above with reference to FIG. 9, using a diffusion model can involve both a forward diffusion process 1505 for adding noise to an image (or features in a latent space) and a reverse diffusion process 1510 for denoising the images (or features) to obtain a denoised image. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate images with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x, such as a noisy image 1515, and denoises the data to obtain the p(xₜ₋₁|xₜ). At each step t-1, the reverse diffusion process 1510 takes xₜ, such as first intermediate image 1520, and t as input. Here, t represents a step in the sequence of transitions associated with different noise levels. The reverse diffusion process 1510 outputs xₜ₋₁, such as second intermediate image 1525, iteratively until x_{T} reverts back to x₀, the original image 430. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x)=N(x_{T}; 0, I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data ã is mapped back into the pixel space from the latent space as output. In some examples, x₀ represents an original input image with low image quality, latent variables x₁, . . . , x_{T} represent noisy images, and \tilde{x} represents the generated image with high image quality.

Accordingly, a method for image generation is described. One or more aspects of the method include obtaining a text prompt and a style input, wherein the text prompt describes image content and the style input describes an image style; generating a text embedding based on the text prompt, wherein the text embedding represents the image content; generating a style embedding based on the style input, wherein the style embedding represents the image style; and generating a synthetic image based on the text embedding and the style embedding, wherein the text embedding is provided to the image generation model at a first step and the style embedding is provided to the image generation model at a second step after the first step.

Some examples of the method further include performing a reverse diffusion process including a plurality of diffusion time steps, wherein the text embedding is provided to the image generation model during a first portion of the plurality of diffusion time steps including the first step, and both the text embedding and the style embedding are provided to the image generation model during a second portion of the plurality of diffusion time steps including the second step and following the first portion.

Some examples of the method further include encoding the style input using a multimodal text encoder to obtain a style text embedding, wherein the style input comprises text. Some examples further include converting the style text embedding to the style embedding using an embedding conversion model.

In some aspects, the style text embedding is in a multimodal embedding space. In some aspects, the style text embedding is based on the text prompt.

Some examples of the method further include encoding the style input using a multimodal image encoder to obtain the style embedding, wherein the style input comprises an image. In some aspects, the style embedding is in a multimodal embedding space. In some aspects, the style embedding is an image embedding comprising semantic information of the style input.

Some examples of the method further include extracting the text prompt and the style input from a user input. Some examples of the method further include providing a plurality of predetermined image styles. Some examples further include receiving a user input selecting at least one of the plurality of predetermined image styles.

Some examples of the method further include displaying a plurality of preview images corresponding to the plurality of predetermined image styles, respectively. Some examples of the method further include generating the style input based on a style image.

A method for image generation is described. One or more aspects of the method include obtaining an image input and a style input, wherein the image input depicts image content and the style input describes an image style; generating an image embedding based on the image input, wherein the image embedding represents the image content; generating a style embedding based on the style input, wherein the style embedding represents the image style; and generating a synthetic image based on the image embedding and the style embedding, wherein the style embedding is provided at a second step of generating the synthetic image after a first step.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

### Training

FIG. 16 shows an example of a flow diagram depicting an algorithm as a step-by-step procedure 1600 in an example implementation of operations performable for training a machine learning model. In some embodiments, the procedure 1600 describes an operation of the training component 1930 described for configuring the machine learning model 1915 as described with reference to FIG. 19. The procedure 1600 provides one or more examples of generating training data, use of the training data to train a machine learning model, and use of the trained machine learning model to perform a task.

To begin in this example, a machine learning system collects training data (block 1602) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1604) to a type of task, for which, the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1606). Initialization of the machine learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine learning model (i.e., predictions) and target values (e.g., as expressed by the training data) to be used to train the machine learning model. Additionally, an optimization algorithm is selected (1612) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1614) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1618) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1620), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the procedure 1600 continues training of the machine learning model using the training data (block 1618) in this example.

If the stopping criterion is met (“yes” from decision block 1620), the trained machine learning model is then utilized to generate an output based on subsequent data (block 1622). The trained machine learning model, for instance, is trained to perform a task as described above and therefore once trained is configured to perform that task based on subsequent data received as an input and processed by the machine learning model.

FIG. 17 shows an example of a method 1700 for training a diffusion model according to aspects of the present disclosure. In some embodiments, the method 1700 describes an operation of the training component 1930 described for configuring the image generation model 1920 as described with reference to FIG. 19. The method 1700 represents an example for training a reverse diffusion process as described above with reference to FIG. 15. In some examples, these operations are performed by a system including a processor executing a set of codes to control functional elements of an apparatus, such as the guided diffusion model described in FIG. 9.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1715, the system at each stage n, starting with stage N, a reverse diffusion process is used to predict the image or image features at stage n-1. For example, the reverse diffusion process can predict the noise that was added by the forward diffusion process, and the predicted noise can be removed from the image to obtain the predicted image. In some cases, an original image is predicted at each stage of the training process.

At operation 1720, the system compares predicted image (or image features) at stage n-1 to an actual image (or image features), such as the image at stage n-1 or the original input image. For example, given observed data x, the diffusion model may be trained to minimize the variational upper bound of the negative log-likelihood-log pe (x) of the training data.

At operation 1725, the system updates parameters of the model based on the comparison. For example, parameters of a U-Net may be updated using gradient descent. Time-dependent parameters of the Gaussian transitions can also be learned.

### Computing Device

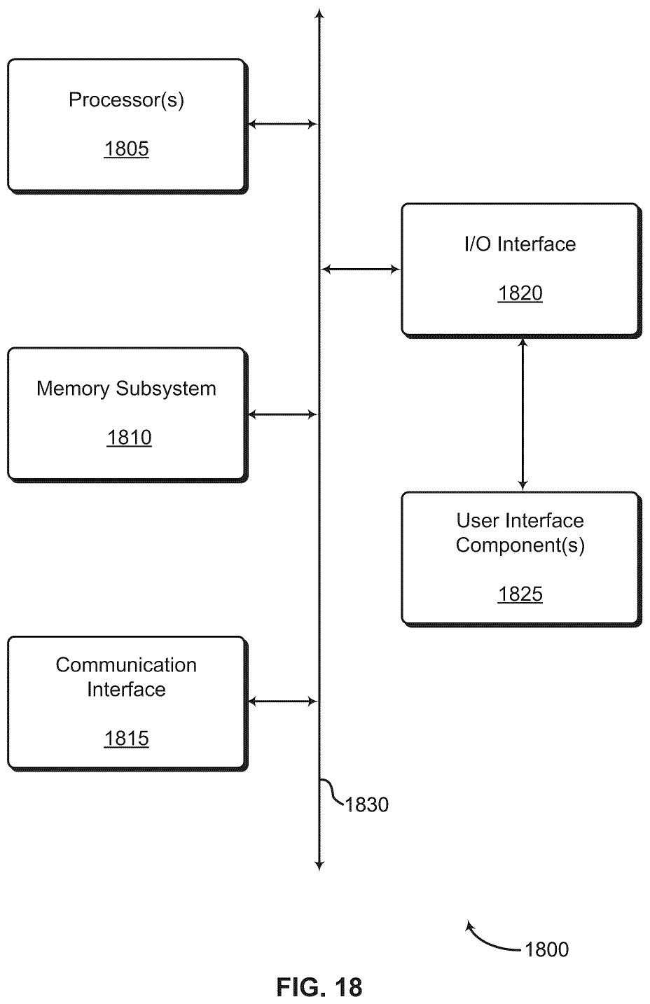

FIG. 18 shows an example of a computing device 1800 according to aspects of the present disclosure. The computing device 1800 may be an example of the image generation apparatus 1900 described with reference to FIG. 19. In one aspect, computing device 1800 includes processor(s) 1805, memory subsystem 1810, communication interface 1815, I/O interface 1820, user interface component(s) 1825, and channel 1830.

In some embodiments, computing device 1800 is an example of, or includes aspects of the image generation model of FIG. 9. In some embodiments, computing device 1800 includes one or more processors 1805 that can execute instructions stored in memory subsystem 1810 to perform image generation.

According to some aspects, computing device 1800 includes one or more processors 1805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or via hardware components controlled by the I/O controller.

According to some aspects, user interface component(s) 1825 enable a user to interact with computing device 1800. In some cases, user interface component(s) 1825 include an audio device, such as an external speaker system, an external display device such as a display screen, an input device (e.g., a remote-control device interfaced with a user interface directly or through the I/O controller), or a combination thereof. In some cases, user interface component(s) 1825 include a GUI.

FIG. 19 shows an example of an image generation apparatus 1900 according to aspects of the present disclosure. Image generation apparatus 1900 is an example of, or includes aspects of, the corresponding element described with reference to FIG. 1. Image generation apparatus 1900 may include an example of, or aspects of, the guided diffusion model described with reference to FIG. 9 and the U-Net described with reference to FIG. 10. In some embodiments, image generation apparatus 1900 includes processor unit 1905, memory unit 1910, machine learning model 1915, image generation model 1920, I/O module 1925, training component 1930, and user interface 1935. Training component 1930 updates parameters of the machine learning model 1915 stored in memory unit 1910. In some examples, the training component 1930 is located outside the image generation apparatus 1900. Machine learning model 1915 is an example of, or includes aspects of, the corresponding element described with reference to FIG. 20.

Processor unit 1905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1905 is configured to operate a memory array using a memory controller. In other cases, a memory controller is integrated into processor unit 1905. In some cases, processor unit 1905 is configured to execute computer-readable instructions stored in memory unit 1910 to perform various functions. In some aspects, processor unit 1905 includes special purpose components for modem processing, baseband processing, digital signal processing, or transmission processing. According to some aspects, processor unit 1905 comprises one or more processors described with reference to FIG. 18.

Memory unit 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1905 to perform various functions described herein.

In some cases, memory unit 1910 includes a basic input/output system (BIOS) that controls basic hardware or software operations, such as an interaction with peripheral components or devices. In some cases, memory unit 1910 includes a memory controller that operates memory cells of memory unit 1910. For example, the memory controller may include a row decoder, column decoder, or both. In some cases, memory cells within memory unit 1910 store information in the form of a logical state. According to some aspects, memory unit 1910 is an example of the memory subsystem 1810 described with reference to FIG. 18.

According to some aspects, image generation apparatus 1900 uses one or more processors of processor unit 1905 to execute instructions stored in memory unit 1910 to perform functions described herein. For example, the image generation apparatus 1900 may obtain a text prompt and a style input, wherein the text prompt describes image content and the style input describes an image style; generate a text embedding based on the text prompt, wherein the text embedding represents the image content; generate a style embedding based on the style input, wherein the style embedding represents the image style; and generate a synthetic image based on the text embedding and the style embedding, wherein the text embedding is provided to the image generation model at a first step and the style embedding is provided to the image generation model at a second step after the first step.

The memory unit 1910 may include a machine learning model 1915 trained to generate a text embedding based on a text prompt describing image content; generate a style embedding based on a style input describing an image style; and generate a synthetic image based on the text embedding and the style embedding, wherein the text embedding is provided to the image generation model at a first step and the style embedding is provided to the image generation model at a second step after the first step. For example, after training, the image generation model 1920 of the machine learning model 1915 may perform inferencing operations as described with reference to FIGS. 14 and 15 to generate a synthetic image based on the text embedding and the style embedding, wherein the text embedding is provided to the image generation model at a first step and the style embedding is provided to the image generation model at a second step after the first step.

In some embodiments, the machine learning model 1915 is an artificial neural network (ANN). In some embodiments, the image generation model 1920 is an ANN such as the guided diffusion model described with reference to FIG. 9 and the U-Net described with reference to FIG. 10. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1915 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1930 may train the machine learning model 1915. For example, parameters of the machine learning model 1915 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 16 and 17). The goal of the training process may be to find optimal values for the parameters that allow the machine learning model 1915 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1915 can be used to make predictions on new, unseen data (i.e., during inference).

According to some aspects, image generation model 1920 generates a synthetic image based on a text embedding and a style embedding, where the text embedding is provided to image generation model 1920 at a first step and the style embedding is provided to the image generation model at a second step after the first step. In some examples, image generation model 1920 generates the synthetic image by performing a reverse diffusion process including a set of diffusion time steps, where the text embedding is provided to image generation model 1920 during a first portion of the set of diffusion time steps including the first step, and both the text embedding and the style embedding are provided to the image generation model 1920 during a second portion of the set of diffusion time steps including the second step and following the first portion. In some examples, image generation model 1920 generates a style input based on a style image.

Image generation model 1920 is an example of, or includes aspects of, the corresponding element described with reference to FIGS. 5 and 20. According to some aspects, image generation model 1920 is implemented as software stored in memory unit 1910 and executable by processor unit 1905, as firmware, as one or more hardware circuits, or as a combination thereof. According to some aspects, image generation model 1920 comprises image generation parameters (e.g., machine learning parameters) stored in memory unit 1910.

I/O module 1925 receives inputs from and transmits outputs of the image generation apparatus 1900 to other devices or users. For example, I/O module 1925 receives inputs for the machine learning model 1915 and transmits outputs of the machine learning model 1915. the According to some aspects, I/O module 1925 is an example of the I/O interface 1820 described with reference to FIG. 18.

User interface 1935 is an example of, or includes aspects of, the corresponding element described with reference to FIGS. 7 and 8. According to some aspects, user interface 1935 is implemented as software stored in memory unit 1910 and executable by processor unit 1905. According to some aspects, user interface 1935 is graphical user interface, a text-based interface, or a combination thereof. According to some aspects, user interface 1935 is configured to receive a text prompt, an image input, a style input, or a combination thereof from a user. According to some aspects, user interface 1935 is configured to display the synthetic image.

According to some aspects, user interface 1935 obtains a text prompt and a style input, where the text prompt describes image content and the style input describes an image style. In some examples, user interface 1935 provides a set of predetermined image styles. In some examples, user interface 1935 receives a user input selecting at least one of the set of predetermined image styles. In some examples, user interface 1935 displays a set of preview images corresponding to the set of predetermined image styles, respectively.

According to some aspects, user interface 1935 obtains an image input and a style input, where the image input depicts image content and the style input describes an image style.

FIG. 20 shows an example of a machine learning model 2000 according to aspects of the present disclosure. In one aspect, machine learning model 2000 includes text encoder 2005, style encoder 2010, image generation model 2030, and image encoder 2035.

According to some aspects, machine learning model 2000 is implemented as software stored in the memory unit 1910 described with reference to FIG. 19 and executable by the processor unit 1905 described with reference to FIG. 19, as firmware, as one or more hardware circuits, or as a combination thereof. According to some aspects, machine learning model 2000 comprises machine learning parameters stored in the memory unit 1910.

According to some aspects, text encoder 2005 is implemented as software stored in the memory unit 1910 described with reference to FIG. 19 and executable by the processor unit 1905 described with reference to FIG. 19, as firmware, as one or more hardware circuits, or as a combination thereof. According to some aspects, text encoder 2005 comprises text encoding parameters (e.g., machine learning parameters) stored in the memory unit 1910.

According to some aspects, text encoder 2005 comprises one or more ANNs trained to generate a text embedding based on a text prompt describing image content, where the text embedding represents the image content. In some aspects, the text encoder 2005 has a different architecture than the style encoder 2010. In some cases, text encoder 2005 comprises a recurrent neural network (RNN), a transformer, or other ANN suitable for encoding textual information. According to some aspects, text encoder 2005 comprises a T5 (e.g., a text-to-text transfer transformer) text encoder.

A recurrent neural network (RNN) is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

In some cases, a transformer comprises one or more ANNs comprising attention mechanisms that enable the transformer to weigh an importance of different words or tokens within a sequence. In some cases, a transformer processes entire sequences simultaneously in parallel, making the transformer highly efficient and allowing the transformer to capture long-range dependencies more effectively.

An attention mechanism is a key component in some ANN architectures, particularly ANNs employed in natural language processing and sequence-to-sequence tasks, which allows an ANN to focus on different parts of an input sequence when making predictions or generating output.

Some sequence models process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains its current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

In some cases, by incorporating an attention mechanism, an ANN dynamically allocates attention to different parts of the input sequence, allowing the ANN to focus on relevant information and capture dependencies across longer distances.

In some cases, calculating attention involves three basic steps. First, a similarity between a query vector Q and a key vector K obtained from the input is computed to generate attention weights. In some cases, similarity functions used for this process include dot product, splice, detector, and the like. Next, a softmax function is used to normalize the attention weights. Finally, the attention weights are weighed together with their corresponding values V. In the context of an attention network, the key K and value V are typically vectors or matrices that are used to represent the input data. The key K is used to determine which parts of the input the attention mechanism should focus on, while the value V is used to represent the actual data being processed.

In some cases, a transformer comprises an encoder-decoder structure. In some cases, the encoder of the transformer processes an input sequence and encodes the input sequence into a set of high-dimensional representations. In some cases, the decoder of the transformer generates an output sequence based on the encoded representations and previously generated tokens. In some cases, the encoder and the decoder are composed of multiple layers of self-attention mechanisms and feed-forward ANNs.

In some cases, the self-attention mechanism allows the transformer to focus on different parts of an input sequence while computing representations for the input sequence. In some cases, the self-attention mechanism captures relationships between words of a sequence by assigning attention weights to each word based on a relevance to other words in the sequence, thereby enabling the transformer to model dependencies regardless of a distance between words.

According to some aspects, style encoder 2010 is implemented as software stored in the memory unit 1910 described with reference to FIG. 19 and executable by the processor unit 1905 described with reference to FIG. 19, as firmware, as one or more hardware circuits, or as a combination thereof. According to some aspects, style encoder 2010 comprises style encoding parameters (e.g., machine learning parameters) stored in the memory unit 1910. According to some aspects, style encoder 2010 comprises one or more ANNs trained to generate a style embedding based on a style input, where the style embedding represents the image style. In some aspects, the style embedding is in a multimodal embedding space. In some aspects, the style embedding is an image embedding including semantic information of the style input.

In one aspect, style encoder 2010 includes multimodal text encoder 2015, embedding conversion model 2020, and multimodal image encoder 2025.

According to some aspects, multimodal text encoder 2015 is implemented as software stored in the memory unit 1910 described with reference to FIG. 19 and executable by the processor unit 1905 described with reference to FIG. 19, as firmware, as one or more hardware circuits, or as a combination thereof. According to some aspects, multimodal text encoder 2015 comprises multimodal text encoding parameters (e.g., machine learning parameters) stored in the memory unit 1910. According to some aspects, multimodal text encoder 2015 comprises one or more ANNs trained to encode the style input to obtain a style text embedding, where the style text input includes text. In some aspects, the style text embedding is in the multimodal embedding space. In some aspects, the style text embedding is based on the text prompt.

According to some aspects, multimodal text encoder 2015 comprises a Contrastive Language-Image Pre-training (CLIP) text encoder. In some cases, a CLIP model comprises a CLIP text encoder and a CLIP image encoder that are jointly trained to efficiently and respectively generate representations of text and images in a multimodal embedding space so that the text and images can be effectively compared with each other based on semantic relations, allowing for an image to be efficiently retrieved based on a text input, and for text to be efficiently retrieved based on an image input.

In some cases, for pre-training, a CLIP model is trained to predict which of N×N possible (image, text) pairings across a batch actually occurred. In some cases, a CLIP model learns the multimodal embedding space by jointly training the CLIP image encoder and the CLIP text encoder to maximize a cosine similarity of image and text embeddings of the N real pairs in the batch while minimizing the cosine similarity of the embeddings of the N²−N incorrect pairings. In some cases, a symmetric cross entropy loss is optimized over the similarity scores.

According to some aspects, embedding conversion model 2020 is implemented as software stored in the memory unit 1910 described with reference to FIG. 19 and executable by the processor unit 1905 described with reference to FIG. 19, as firmware, as one or more hardware circuits, or as a combination thereof. According to some aspects, embedding conversion model 2020 comprises embedding conversion parameters (e.g., machine learning parameters) stored in the memory unit 1910. According to some aspects, embedding conversion model 2020 comprises one or more ANNs trained to convert the style text embedding to the style embedding. In some cases, the style embedding is an image embedding (e.g., a CLIP image embedding) in the multimodal embedding space.

In some aspects, embedding conversion model 2020 includes an autoregressive model trained to autoregressively predict the style embedding based on the style text embedding.

In some aspects, embedding conversion model 2020 includes a diffusion model. In some cases, the diffusion model is trained to predict the style embedding by iteratively removing noise from a noised style text embedding, where the noised style text embedding is generated by image generation apparatus by iteratively adding noise to the style text embedding according to a Gaussian probability distribution. For example, in some cases, embedding conversion model 2020 performs a reverse diffusion process based on the noised style text embedding similar to the reverse diffusion process described with reference to FIGS. 9 and 15, and the image generation apparatus 1900 described with reference to FIG. 19 performs a forward diffusion process based on the style text embedding similar to the forward diffusion process described with reference to FIGS. 9 and 15.

According to some aspects, embedding conversion model 2020 is trained based on CLIP embeddings that provide a high level of abstraction on text and images, allowing embedding conversion model 2020 to be quickly trained on a relatively small amount of training data.

According to some aspects, multimodal image encoder 2025 is implemented as software stored in the memory unit 1910 described with reference to FIG. 19 and executable by the processor unit 1905 described with reference to FIG. 19, as firmware, as one or more hardware circuits, or as a combination thereof. According to some aspects, multimodal image encoder 2025 comprises multimodal image encoding parameters (e.g., machine learning parameters) stored in the memory unit 1910. In some cases, multimodal image encoder 2025 is omitted from machine learning model 2000. According to some aspects, multimodal image encoder 2025 comprises one or more ANNs trained to encode the style input to obtain the style embedding, where the style input includes an image. In some cases, multimodal image encoder 2025 comprises a CLIP image encoder.

According to some aspects, image encoder 2035 is implemented as software stored in the memory unit 1910 described with reference to FIG. 19 and executable by the processor unit 1905 described with reference to FIG. 19, as firmware, as one or more hardware circuits, or as a combination thereof. According to some aspects, image encoder 2035 comprises image encoding parameters (e.g., machine learning parameters) stored in the memory unit 1910. According to some aspects, image encoder 2035 comprises one or more ANNs trained to generate an image embedding based on the image input, where the image embedding represents the image content.

According to some aspects, image encoder 2035 includes one or more ANNs trained to generate an image embedding based on an image input, such as a convolutional neural network (CNN). A CNN is a class of ANN that is commonly used in computer vision or image classification systems. In some cases, a CNN enables processing of digital images with minimal pre-processing. In some cases, a CNN is characterized by the use of convolutional (or cross-correlational) hidden layers. In some cases, the convolutional layers apply a convolution operation to an input before signaling a result to the next layer. In some cases, each convolutional node processes data for a limited field of input (i.e., a receptive field). In some cases, during a forward pass of the CNN, filters at each layer may be convolved across the input volume, computing the dot product between the filter and the input. In some cases, during a training process, the filters may be modified so that they activate when they detect a particular feature within the input.

Machine learning model 2000 is an example of, or includes aspects of, the corresponding element described with reference to FIG. 19. Text encoder 2005 is an example of, or includes aspects of, the corresponding element described with reference to FIG. 5. Style encoder 2010 is an example of, or includes aspects of, the corresponding element described with reference to FIGS. 5 and 6. Multimodal text encoder 2015 is an example of, or includes aspects of, the corresponding element described with reference to FIG. 6. Embedding conversion model 2020 is an example of, or includes aspects of, the corresponding element described with reference to FIG. 6. Multimodal image encoder 2025 is an example of, or includes aspects of, the corresponding element described with reference to FIG. 6. Image generation model 2030 is an example of, or includes aspects of, the corresponding element described with reference to FIGS. 5 and 19.

Accordingly, a system and apparatus for image generation are described. One or more aspects of the system and apparatus include one or more processors; one or more memory components coupled with the one or more processors; a text encoder comprising text encoding parameters stored in the one or more memory components, the text encoder trained to generate a text embedding based on a text prompt describing image content; a style encoder comprising style encoding parameters stored in the one or more memory components, the style encoder trained to generate a style embedding based on a style input describing an image style; and an image generation model comprising image generation parameters stored in the one or more memory components, the image generation model trained to generate a synthetic image based on the text embedding and the style embedding, wherein the text embedding is provided to the image generation model at a first step and the style embedding is provided to the image generation model at a second step after the first step.

Some examples of the system and apparatus further include an image encoder trained to generate an image embedding based on an image. Some examples of the system and apparatus further include a user interface configured to display the synthetic image to a user. In some aspects, the image generation model comprises a diffusion model.

In some aspects, the style encoder further comprises an embedding conversion model configured to convert the style text embedding to the style embedding, wherein the embedding conversion model comprises an autoregressive model or a diffusion model. In some aspects, the style encoder further comprises a multimodal text encoder configured to obtain a style text embedding, wherein the style input comprises text. In some aspects, the style encoder further comprises a multimodal image encoder configured to obtain the style embedding, wherein the style input comprises an image.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining a text prompt and a style input, wherein the text prompt describes image content and the style input describes an image style;
generating, using a text encoder, a text embedding based on the text prompt, wherein the text embedding represents the image content;
generating, using a style encoder, a style embedding based on the style input, wherein the style embedding represents the image style; and
generating, using an image generation model, a synthetic image based on the text embedding and the style embedding, wherein the text embedding is provided to the image generation model at a first step and the style embedding is provided to the image generation model at a second step after the first step.

2. The method of claim 1, wherein generating the synthetic image comprises:
performing, using the image generation model, a reverse diffusion process including a plurality of diffusion time steps, wherein the text embedding is provided to the image generation model during a first portion of the plurality of diffusion time steps including the first step, and both the text embedding and the style embedding are provided to the image generation model during a second portion of the plurality of diffusion time steps including the second step and following the first portion.

3. The method of claim 1, wherein generating the style embedding comprises:
encoding the style input using a multimodal text encoder to obtain a style text embedding, wherein the style input comprises text; and
converting the style text embedding to the style embedding using an embedding conversion model.

4. The method of claim 3, wherein:
the style text embedding is in a multimodal embedding space.

5. The method of claim 3, wherein:
the style text embedding is based on the text prompt.

6. The method of claim 1, wherein generating the style embedding comprises:
encoding the style input using a multimodal image encoder to obtain the style embedding, wherein the style input comprises an image.

7. The method of claim 1, wherein:
the style embedding is in a multimodal embedding space.

8. The method of claim 1, wherein:
the style embedding is an image embedding comprising semantic information of the style input.

9. The method of claim 1, wherein obtaining the text prompt and the style input comprises:
extracting the text prompt and the style input from a user input.

10. The method of claim 1, wherein obtaining the style input comprises:
providing a plurality of predetermined image styles; and
receiving a user input selecting at least one of the plurality of predetermined image styles.

11. The method of claim 10, wherein obtaining the style input comprises:
displaying a plurality of preview images corresponding to the plurality of predetermined image styles, respectively.

12. The method of claim 1, wherein obtaining the style input comprises:
generating the style input based on a style image.

13. A non-transitory computer readable medium storing code for media processing, the code comprising instructions that, when executed by at least one processor, cause the at least one processor to perform operations comprising:
obtaining an image input and a style input, wherein the image input depicts image content and the style input describes an image style;
generating, using an image generation model, a first intermediate output based on the content input during a first stage of a diffusion process;
generating, using the image generation model, a second intermediate output based on the first intermediate output and the style input during a second stage of the diffusion process; and
generating, using the image generation model, a synthetic image based on the second intermediate output, wherein the style embedding is provided at a second step of generating the synthetic image after a first step.

14. The non-transitory computer readable medium of claim 13, the code further comprising instructions that, when executed by the at least one processor, cause the at least one processor to perform operations comprising:
generating, using a text encoder, a text embedding based on the text prompt, wherein the text embedding represents the image content and wherein the first intermediate output is based on the text embedding; and
generating, using a style encoder, a style embedding based on the style input, wherein the style embedding represents the image style and the second intermediate output is based on the style embedding.

15. A system for image generation, comprising:
a memory component; and
a processing device coupled to the memory component, the processing device configured to perform operations comprising:
obtaining a text prompt and a style input, wherein the text prompt describes image content and the style input describes an image style;
generating, using a text encoder, a text embedding based on the text prompt, wherein the text embedding represents the image content;
generating, using a style encoder, a style embedding based on the style input, wherein the style embedding represents the image style; and
generating, using an image generation model, a synthetic image based on the text embedding and the style embedding, wherein the text embedding is provided to the image generation model at a first step and the style embedding is provided to the image generation model at a second step after the first step.

16. The system of claim 15, the system further comprising:
an image encoder trained to generate an image embedding based on an image.

17. The system of claim 15, the system further comprising:
a user interface configured to display the synthetic image to a user.

18. The system of claim 15, wherein:
the image generation model comprises a diffusion model.

19. The system of claim 15, wherein:
the style encoder further comprises an embedding conversion model configured to convert the style text embedding to the style embedding, wherein the embedding conversion model comprises an autoregressive model or a diffusion model.

20. The system of claim 15, wherein:
the style encoder further comprises a multimodal text encoder configured to obtain a style text embedding, wherein the style input comprises text or an image.
